(19) United States
(12) Patent Application Publication
(10) Pub. No.: US 2022/0318876 A1
(43) Pub. Date: Oct. 6, 2022

(54) DYNAMIC METADATA GENERATION AND PROCESSING

(71) Applicant: Apple Inc., Cupertino, CA (US)

(72) Inventors: Ken T. LOH, San Jose, CA (US); Baris CETINOK, Los Altos, CA (US); Jennifer J. BAILEY, Los Altos Hills, CA (US); Toby C. PATERSON, Los Altos Hills, CA (US); Pascal A. CAILLON, San Francisco, CA (US); Alexis BORDET, San Francisco, CA (US); John L. FURLAN, Emerald Hills, CA (US); Joelle L. LAM, Palo Alto, CA (US); Daniel A. CUMMINGS, San Jose, CA (US)

(21) Appl. No.: 17/654,391

(22) Filed: Mar. 10, 2022

Related U.S. Application Data
(60) Provisional application No. 63/168,121, filed on Mar. 30, 2021.

(51) Int. Cl. G06Q 30/06; G06T 19/00

(52) U.S. Cl. CPC G06Q 30/0621; G06Q 30/0643; G06T 19/006

(57) ABSTRACT

In some embodiments, an electronic device obtains and displays a file container defining a virtual object corresponding to a physical object. The file container also defines a plurality of other permitted configurations of the virtual object. At a later time, the electronic device displays the virtual object using an alternate process. In response to a user input corresponding to a request to update a configuration of the object, the electronic device contacts the source of the object to obtain the availability of the updated configuration of the object. In some embodiments, in response to an indication that the physical object with the updated configuration is available, the electronic device presents the virtual object with the updated configuration.

### CROSS-REFERENCE TO RELATED APPLICATIONS

This application claims the benefit of U.S. Provisional Application No. 63/168,121, filed Mar. 30, 2021, the content of which is incorporated herein by reference in its entirety for all purposes.

### FIELD OF THE DISCLOSURE

This relates generally to the presentation of objects in computerized environments, and, more particularly, to the presentation of objects using dynamic metadata in such environments.

### BACKGROUND OF THE DISCLOSURE

Online marketplaces can enable manufacturers and retailers to market goods to potential customers. The online marketplaces can include information about goods for sale, including one or more images of the goods and one or more available configurations of the goods. Some online marketplaces can enable users to view virtual representations of marketable goods in augmented reality (AR), for example, illustrate to the user the actual size and/or scale of the marketable goods.

### SUMMARY OF THE DISCLOSURE

Some embodiments described in this disclosure are directed to the display of virtual objects. For example, a virtual object can correspond to a physical object that is available for purchase. In some embodiments, an electronic device can display the virtual object based on a file that defines dynamic metadata of the object. For example, multiple variations of the physical object can be available. In some embodiments, in response to a request to display the virtual object with a different configuration that the current configuration of the virtual object, the electronic device can contact a source of the virtual object (e.g., a second electronic device, such as a server, associated with a manufacturer or retailer of the object) to obtain the availability (e.g., for purchase) of the physical object with the requested configuration. In some embodiments, the electronic device requests and/or receives frequent updates from the source of the virtual objects as the availability of various configurations changes. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1 illustrates an electronic device displaying XR content according to some embodiments of the disclosure.

FIG. 2 illustrates a block diagram of exemplary architectures for an electronic device according to some embodiments of the disclosure.

FIGS. 3A-3D illustrate exemplary ways in which an electronic device presents options associated with a virtual object according to some embodiments.

FIGS. 4A-4B illustrate exemplary ways in which an electronic device presents an option associated with a virtual object according to some embodiments.

FIGS. 5A-5B illustrate exemplary ways in which an electronic device presents configuration information associated with a real object in the physical environment of the electronic device in accordance with some embodiments.

FIG. 6A illustrates an exemplary notification related to a virtual object in accordance with some embodiments.

FIG. 6B illustrates the electronic device presenting a web browsing user interface and a virtual collection user interface in accordance with some embodiments.

FIG. 7 illustrates an exemplary file defining a virtual object corresponding to a real object in accordance with some embodiments.

FIG. 8 illustrates an example process for presenting virtual objects according to some embodiments.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments. Further, although the following description uses terms “first,” “second,” etc. to describe various elements, these elements should not be limited by the terms. These terms are only used to distinguish one element from another. For example, a first object or first file could be termed a second object or second file, and, similarly, a second object or second file could be termed a first object or first file, without departing from the scope of the various described embodiments. The first object and the second object are both objects, but they are not the same object. Likewise, the first file and the second file are both files, but they are not the same file.

Some embodiments described in this disclosure are directed to the display of virtual objects. For example, a virtual object can correspond to a physical object that is available for purchase. In some embodiments, an electronic device can display the virtual object based on a file that defines dynamic metadata of the object. For example, multiple variations of the physical object can be available. In some embodiments, in response to a request to display the virtual object with a different configuration that the current configuration of the virtual object, the electronic device can contact a source of the virtual object (e.g., a second electronic device, such as a server, associated with a manufacturer or retailer of the object) to obtain the availability (e.g., for purchase) of the physical object with the requested configuration. In some embodiments, the electronic device requests and/or receives frequent updates from the source of the virtual objects as the availability of various configurations changes. The full descriptions of the embodiments are provided in the Drawings and the Detailed Description, and it is understood that this Summary does not limit the scope of the disclosure in any way.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, an extended reality (XR) environment refers to a wholly or partially simulated environment that people sense and/or interact with via an electronic system. In some embodiments of a XR, a subset of a person's physical motions, or representations thereof, are tracked, and, in response, one or more characteristics of one or more virtual objects simulated in the XR environment are adjusted in a manner that comports with at least one law of physics. For example, a XR system may detect the device turning and/or moving and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). Examples of XR include virtual reality, mixed reality, and augmented reality.

A person may sense and/or interact with a XR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects. Examples of XR include virtual reality and mixed reality.

There are many different types of electronic systems that enable a person to sense and/or interact with various XR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

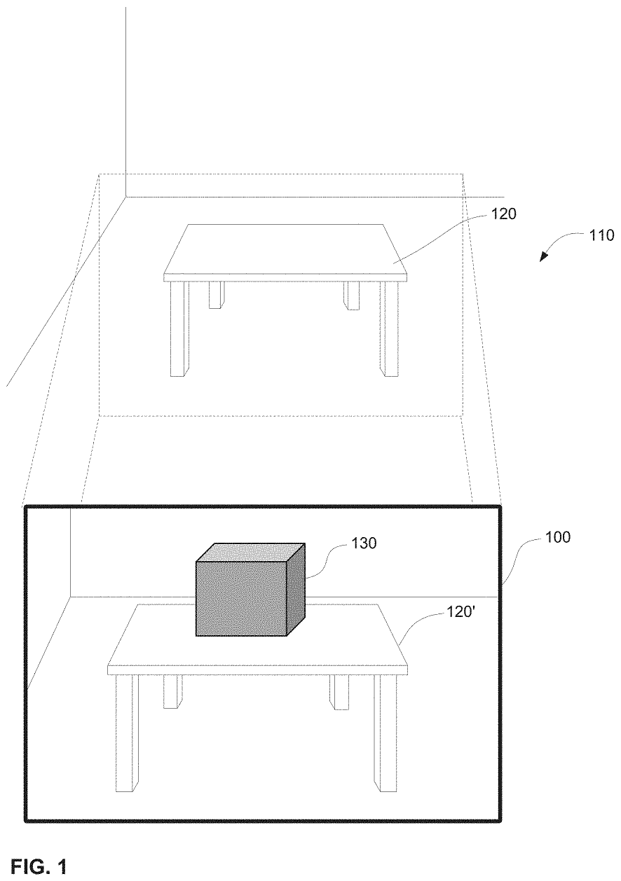

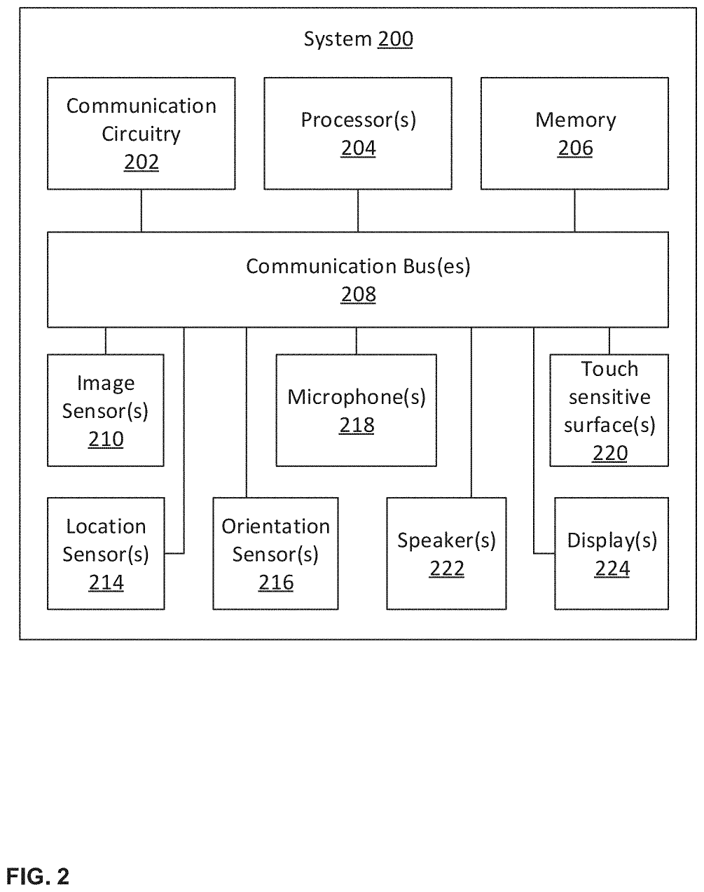

FIG. 1 illustrates an electronic device 100 displaying XR content according to some embodiments of the disclosure. In some embodiments, electronic device 100 is a handheld or mobile device, such as a tablet computer, laptop computer or a smartphone. Examples of device 100 are described below with reference to FIG. 2. As shown in FIG. 1, electronic device 100 and table 120 are located in the physical environment 110. In some embodiments, electronic device 100 may be configured to capture areas of physical environment 110 including table 120 (illustrated in the field of view of electronic device 100). In some embodiments, in response to a trigger, the electronic device 100 may be configured to display a 3D XR object 130 (e.g., a cube illustrated in FIG. 1) positioned on top of a XR representation 120′ of real-world table 120. For example, object 130 can be displayed on the surface of the table 120′ in the XR environment displayed on device 100 in response to detecting the planar surface of table 120 in the physical environment 110. In some embodiments, the electronic device 100 is able to display virtual objects on virtual surfaces of other virtual objects. For example, if table 120 were not in the physical environment 110 of the electronic device 100 and the electronic device 100 displayed virtual table 120′ not based on physical table 120, the electronic device 100 could still display cube 130 on the surface of virtual table 120′. In some embodiments, a user may desire to view a virtual object corresponding to a physical object available for purchase in a XR environment. The electronic device can display the virtual object based on a file that includes one or more attributes of the object with adjustable values. In some embodiments, the file defines a source of the physical object corresponding to the virtual object and the electronic device is able to contact the source of the physical object corresponding to the virtual object to obtain real-time availability (e.g., for purchase) of the object with various configurations. The examples described herein describe systems and methods of dynamically updating one or more attributes of virtual objects that correspond to real objects.

FIG. 2 illustrates a block diagram of exemplary architectures for a system or device 200 in accordance with some embodiments. In some embodiments, device 200 is a mobile device, such as a mobile phone (e.g., smart phone), a tablet computer, a laptop computer, a desktop computer, an auxiliary device in communication with another device, etc. In some embodiments, as illustrated in FIG. 2, device 200 includes various components, such as communication circuitry 202, processor(s) 204, memory 206, image sensor(s) 210, location sensor(s) 214, orientation sensor(s) 216, microphone(s) 218, touch-sensitive surface(s) 220, speaker(s) 222, and/or display generation component(s) 224. These components optionally communicate over communication bus(es) 208 of device 200.

Device 200 includes communication circuitry 202. Communication circuitry 202 optionally includes circuitry for communicating with electronic devices, networks, such as the Internet, intranets, a wired network and/or a wireless network, cellular networks and wireless local area networks (LANs). Communication circuitry 202 optionally includes circuitry for communicating using near-field communication and/or short-range communication, such as Bluetooth®.

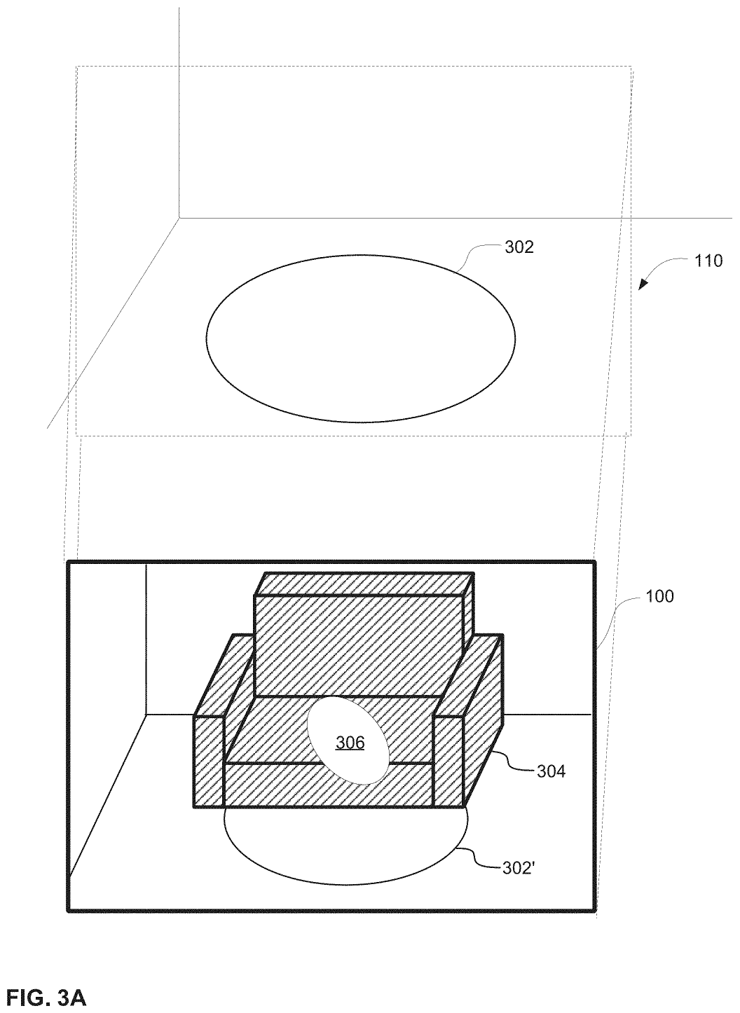

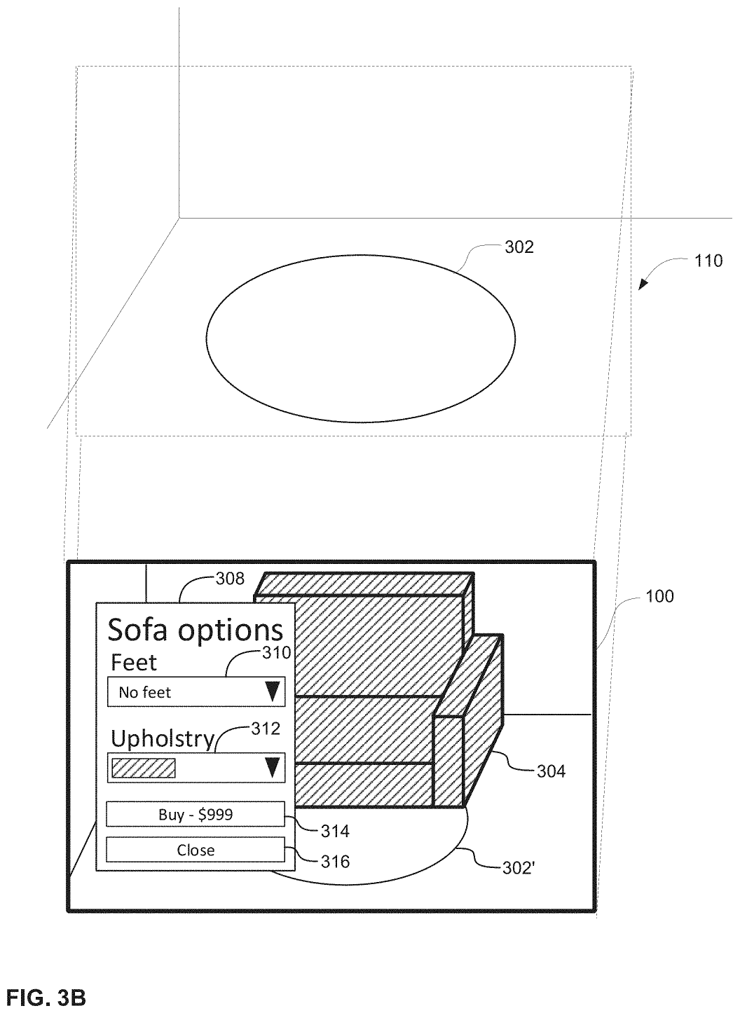

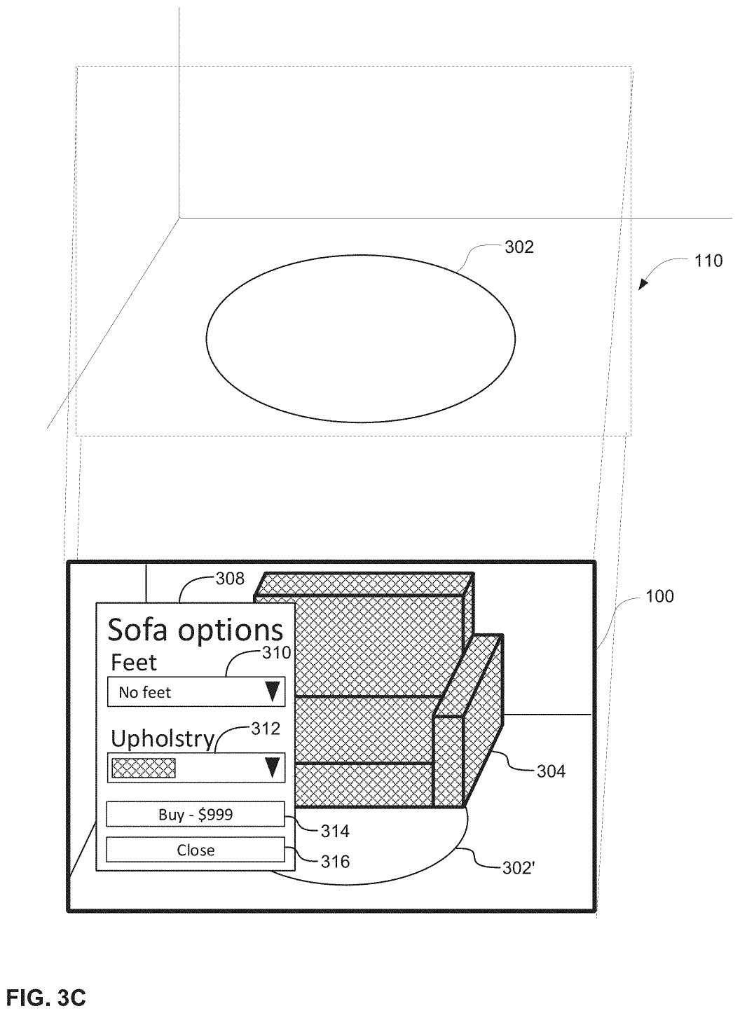

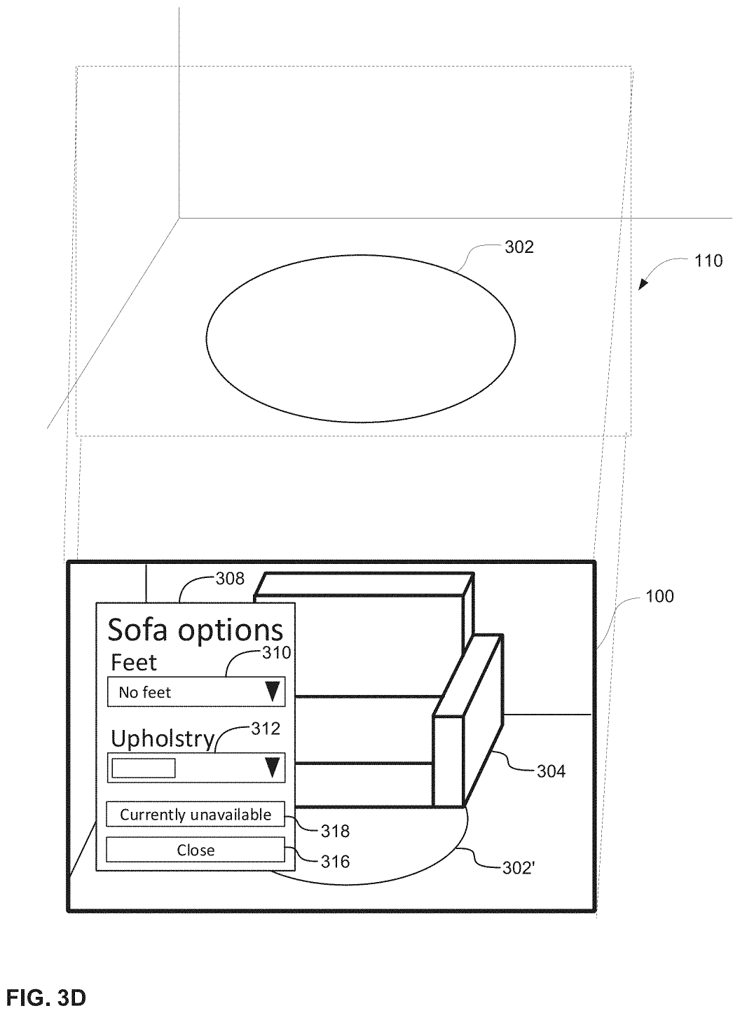

Processor(s) 204 include one or more general processors, one or more graphics processors, and/or one or more digital signal processors. In some embodiments, memory 206 is a non-transitory computer-readable storage medium (e.g., flash memory, random access memory) that stores computer-readable instructions configured to be executed by processor(s) 204 to perform the techniques, processes, and/or methods described below (e.g., with reference to FIGS. 3-8B). In some embodiments, memory 206 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

Device 200 includes display generation component(s) 224. In some embodiments, display generation component(s) 224 can include a single display such as an LED or LCD display, and in other embodiments the display generation component(s) can include a projector, a display with touch capability, a retinal projector, and the like. In some embodiments, display generation component(s) 224 includes multiple displays. In some embodiments, device 200 includes touch-sensitive surface(s) 220 for receiving user inputs, such as tap inputs and swipe inputs or other gestures. In some embodiments, display generation component(s) 224 and touch-sensitive surface(s) 220 form touch-sensitive display(s), for example a touch screen integrated with device 200 or external to device 200 that is in communication with device 200.

Device 200 optionally includes image sensor(s) 210. Image sensors(s) 210 optionally include one or more visible light image sensor, such as charged coupled device (CCD) sensors, and/or complementary metal-oxide-semiconductor (CMOS) sensors operable to obtain images of physical objects from the real environment. Image sensor(s) 210 also optionally include one or more infrared (IR) sensor(s), such as a passive IR sensor or an active IR sensor, for detecting infrared light from the real environment. For example, an active IR sensor includes an IR emitter, such as an IR dot emitter, for emitting infrared light into the real environment. Image sensor(s) 210 also optionally include one or more event camera(s) configured to capture movement of physical objects in the real environment. Image sensor(s) 210 also optionally include one or more depth sensor(s) configured to detect the distance of physical objects from device 200. In some embodiments, information from one or more depth sensor(s) can allow the device to identify and differentiate objects in the real environment from other objects in the real environment. In some embodiments, one or more depth sensor(s) can allow the device to determine the texture and/or topography of objects in the real environment.

In some embodiments, device 200 uses CCD sensors, event cameras, and depth sensors in combination to detect the physical environment around device 200. In some embodiments, image sensor(s) 220 include a first image sensor and a second image sensor. The first image sensor and the second image sensor work in tandem and are optionally configured to capture different information of physical objects in the real environment. In some embodiments, the first image sensor is a visible light image sensor and the second image sensor is a depth sensor. In some embodiments, device 200 uses image sensor(s) 210 to detect the position and orientation of device 200 and/or display generation component(s) 224 in the real environment. For example, device 200 uses image sensor(s) 210 to track the position and orientation of display generation component(s) 224 relative to one or more fixed objects in the real environment.

In some embodiments, device 200 includes microphones(s) 218. Device 200 uses microphone(s) 218 to detect sound from the user and/or the real environment of the user. In some embodiments, microphone(s) 218 includes an array of microphones (including a plurality of microphones) that optionally operate in tandem, such as to identify ambient noise or to locate the source of sound in space of the real environment.

Device 200 includes location sensor(s) 214 for detecting a location of device 200 and/or display generation component(s) 224. For example, location sensor(s) 214 can include a GPS receiver that receives data from one or more satellites and allows device 200 to determine the device's absolute position in the physical world.

Device 200 includes orientation sensor(s) 216 for detecting orientation and/or movement of device 200 and/or display generation component(s) 224. For example, device 200 uses orientation sensor(s) 216 to track changes in the position and/or orientation of device 200 and/or display generation component(s) 224, such as with respect to physical objects in the real environment. Orientation sensor(s) 216 optionally include one or more gyroscopes and/or one or more accelerometers. Device 200 is not limited to the components and configuration of FIG. 2, but can include other or additional components in multiple configurations.

Attention is now directed towards examples of graphical user interfaces (“GUIs”) and associated processes that are implemented on an electronic device, such as electronic device 100 or device 200. The GUIs can include display of one or more configurable virtual objects corresponding to physical objects.

FIGS. 3A-3D illustrate exemplary ways in which electronic device 100 presents options associated with a virtual object according to some embodiments. As shown in FIG. 3A, in some embodiments, electronic device 100 can present a representation of physical environment 110, including a XR representation 302′ of a rug 302 in the physical environment 110 and a virtual sofa 304. In some embodiments, virtual sofa 304 can correspond to a physical sofa that is available for purchase through a retailer and/or manufacturer.

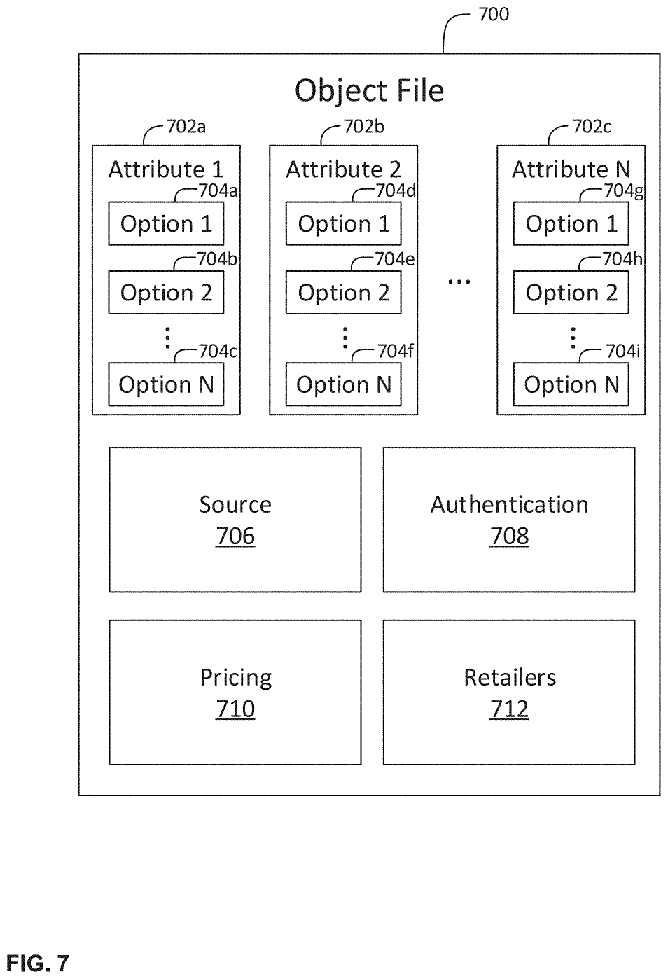

In some embodiments, the electronic device 100 presents the virtual sofa 304 based on a file having the same or a similar format as file 700 described below with reference to FIG. 7. The file can be provided by a source of the virtual sofa 304. In some embodiments, the source is a second electronic device (e.g., a server) associated with a retailer and/or manufacturer of the physical sofa that corresponds to virtual sofa 304. The file corresponding to virtual sofa 304 can include the configuration of one or more characteristics with which the virtual sofa 304 is presently displayed and an indication of the source of the virtual sofa 304. For example, the one or more characteristics can include options available to a customer looking to purchase the physical sofa corresponding to virtual sofa 304, such as upholstery style, foot style, and size. Other characteristics are possible. In some embodiments, the virtual sofa 304 is displayed in a XR environment that is not uniquely associated with the source of the virtual sofa 304. For example, rather than displaying virtual sofa 304 in a XR environment associated with an online store of the source of virtual sofa 304, the virtual sofa 304 can be displayed in a XR environment in which virtual objects from a plurality of sources can be displayed. In some embodiments, the other virtual objects in the XR environment can be other virtual objects corresponding to physical objects available for purchase, one or more items of content, one or more application windows, or other virtual content accessible to the electronic device 100.

In some embodiments, in response to detecting a request from the user to change one or more of the characteristics of virtual sofa 304, the electronic device 100 transmits a query of the availability of the updated characteristics to the source of the virtual sofa 304. In response, in some embodiments, the electronic device 100 receives an indication of the availability of the updated characteristics from the source of the virtual sofa. As shown in FIG. 3A, the electronic device 100 detects a user input selecting the virtual sofa 304, for example. In some embodiments, the user input is the user touching the virtual sofa 304 with hand 306. For example, electronic device 100 includes a touch screen and the electronic device 100 detects hand 306 touching the location of the touch screen at which the virtual sofa 304 is displayed. In some embodiments, the electronic device 100 can communicate with other types of input devices. Thus, the user input selecting the sofa can be an input other than a touch input.

In FIG. 3B, in response to the selection of virtual sofa 304 illustrated in FIG. 3A, the electronic device 100 presents a menu 308 including the mutable characteristics of the virtual sofa 304. For example, menu 308 can include a menu 310 of options for the style of feet for the virtual sofa 304 and a menu 312 of options for the upholstery of the sofa. In some embodiments, the menu 308 further includes an option 314 that, when selected, causes the electronic device 100 to initiate a process to purchase a physical sofa having the same configuration as virtual sofa 304 and an option 314 that, when selected, causes the electronic device 100 to cease display of the menu 308.

In some embodiments, the characteristics included in menu 308 can be defined by characteristics included in a file the electronic device 100 uses to generate virtual sofa 304. In some embodiments, the electronic device 100 transmits a request for the currently-available characteristics of the virtual sofa 304 to the source of the virtual sofa 304 in response to selection of the virtual sofa 304 in FIG. 3A, prior to displaying menu 308. For example, over time, the values for each characteristic and/or the characteristics that can be modified by the user can change depending on the configurations of the physical sofa that are currently available from the source. In some embodiments, the source of the virtual sofa 304 transmits updated configurations to the electronic device 100 on-demand or automatically (e.g., at regular time intervals, whenever the available configurations change). In some embodiments, the configurations of the virtual sofa 304 are stored remotely from the electronic device 100 (e.g., on a server associated with the source of the virtual sofa 304) and the electronic device 100 contacts the remote storage location in response to an input corresponding to a request to present virtual sofa 304 to obtain the available configurations of the virtual sofa 304.

In some embodiments, the electronic device is also capable of presenting other virtual objects that correspond to physical objects available for sale, but do not include, in the file defining the virtual object, purchasing information, such as the logic for completing a purchase through interaction with the virtual object. In these situations, the electronic device may present the virtual object and one or more menus for configuring the virtual object (e.g., similar to menus 310 and 312 associated with virtual sofa 304), but may not present an option to purchase the object (e.g., similar to option 314), for example. In some embodiments, virtual objects that do not include purchasing logic may still be user-configurable based on configuration settings embedded in the file defining the object. In some embodiments, when presenting a virtual object provided by a source that is not authorized by the manufacturer of the physical object corresponding to the virtual object, the electronic device does not contact the source of the virtual object to dynamically update the available configurations for the virtual object.

In some embodiments, in response to detecting selection of a different value for either characteristic of the virtual sofa 304 via user interaction with menu 310 or menu 312, the electronic device 100 can transmit a query of the availability of the selected configuration to the source of virtual sofa 304. In some embodiments, in response to receiving an indication from the source that the selected configuration is available (e.g., for purchase), the electronic device 100 updates the virtual sofa 304 to be displayed with the selected configuration. In some embodiments, the source of the virtual sofa 304 checks for the availability of each characteristic in the configuration separately (e.g., checking for sofas with no feet and checking for sofas with the selected upholstery). In some embodiments, the source of the virtual sofa 304 checks for the availability of the characteristics of the configuration in combination (e.g., checking for sofas with no feet with the selected upholstery).

For example, in FIG. 3C, the electronic device 100 presents the virtual sofa 304 with different upholstery than the upholstery of virtual sofa 304 in FIG. 3B. In some embodiments, the electronic device 100 updates virtual sofa 304 as shown in FIG. 3C in response to detecting a sequence of one or more user inputs including selection of the updated upholstery style in menu 312. In some embodiments, the electronic device 100 displays the updated virtual sofa 304 in FIG. 3C in response to receiving an indication from the source of the virtual sofa 304 that the selected upholstery is available.

In some embodiments, if the price of the virtual sofa 304 with the updated configuration is different from the price of the virtual sofa 304 with the previous indication, the electronic device 100 can update the indication of the price of the sofa included in the option 314 to purchase the physical sofa corresponding to virtual sofa 304. In some embodiments, the price of the sofa can change over time due to sales and promotions. In some embodiments, by querying the source of the sofa for the current price of the sofa, the electronic device 101 is able to present current and accurate pricing information that takes into account any relevant sales and/or promotions. In some embodiments, factors such as other items in a user's shopping cart can impact the pricing information presented by the electronic device. For example, a seller can run a buy one get one free promotion or a free shipping promotion based on the total purchase price of a user's shopping cart that causes the pricing information to change based on the available promotion and whether or not the user's shopping cart qualifies of the promotion.

In some situations, the user may request a configuration of virtual sofa 304 that is not currently available. In some embodiments, in response to the user's request, the electronic device 100 transmits a query of availability of the configuration requested by the user to the source of the virtual sofa 304 and, in response, receives an indication from the source that the requested configuration is unavailable (e.g., instead of receiving an indication of availability and price, as would be the case if the configuration were available). In some embodiments, as shown in FIG. 3D, in response to the indication that the requested configuration is not available, the electronic device 100 displays an indications 318 within menu 308 that the requested configuration is not available. For example, in FIG. 3D, the user has selected an upholstery style from menu 312 that is different from the upholstery styles shown in FIGS. 3A-3C. In some embodiments, as shown in FIG. 3D, the electronic device 100 updates display of the virtual sofa 304 to be displayed with the configuration requested by the user even though the configuration is not available. In some embodiments, however, rather than updating the virtual sofa 304 to be displayed with the unavailable configuration, the electronic device 100 forgoes updating the virtual sofa 304. Instead, in some examples such as the illustrated example of FIG. 3C, the electronic device 100 continues to display the virtual sofa 304 as illustrated. In some examples, the electronic device 100 ceases display of the virtual sofa 304 in the XR environment. In some embodiments, a requested object can be unavailable because it is unavailable for purchase (e.g., the physical object with the requested configuration is sold out) or because the source of the object cannot validate digital rights management information associated with the requested configuration. For example, the digital rights management information may not be validated because the source of the virtual object is not permitted (e.g., by a manufacturer of the physical object) to sell the physical item with the requested configuration.

It should be appreciated that electronic device 100 is able to adjust characteristics of the virtual sofa 304 and, more generally, of other virtual objects corresponding to physical objects available for purchase, other than the upholstery style. For example, the electronic device 100 is able to present the virtual sofa 304 with different configurations for the foot style of the sofa in a manner similar to the manner in which the electronic device 100 displays the virtual sofa 304 with a variety of upholstery styles. For example, in response to detecting the user select a different foot style from menu 310, the electronic device 100 transmits a query to the source of the sofa to obtain the availability of the sofa with a configuration including the user-selected foot style. In some embodiments, virtual sofa 304 includes additional characteristics that can be similarly modified by the user.

As described above with reference to FIGS. 3A-3D, in some embodiments, virtual objects can have a plurality of characteristics that can be modified by a user of electronic device 100. In some embodiments, the electronic device presents virtual objects that include one characteristic that can be modified by the user.

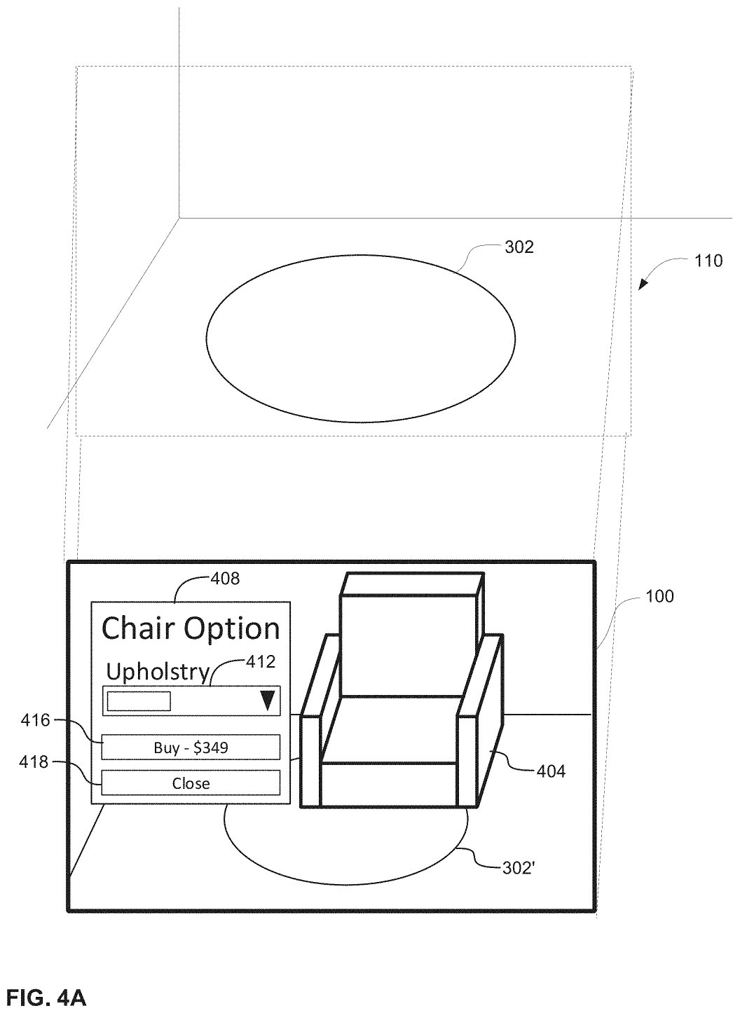

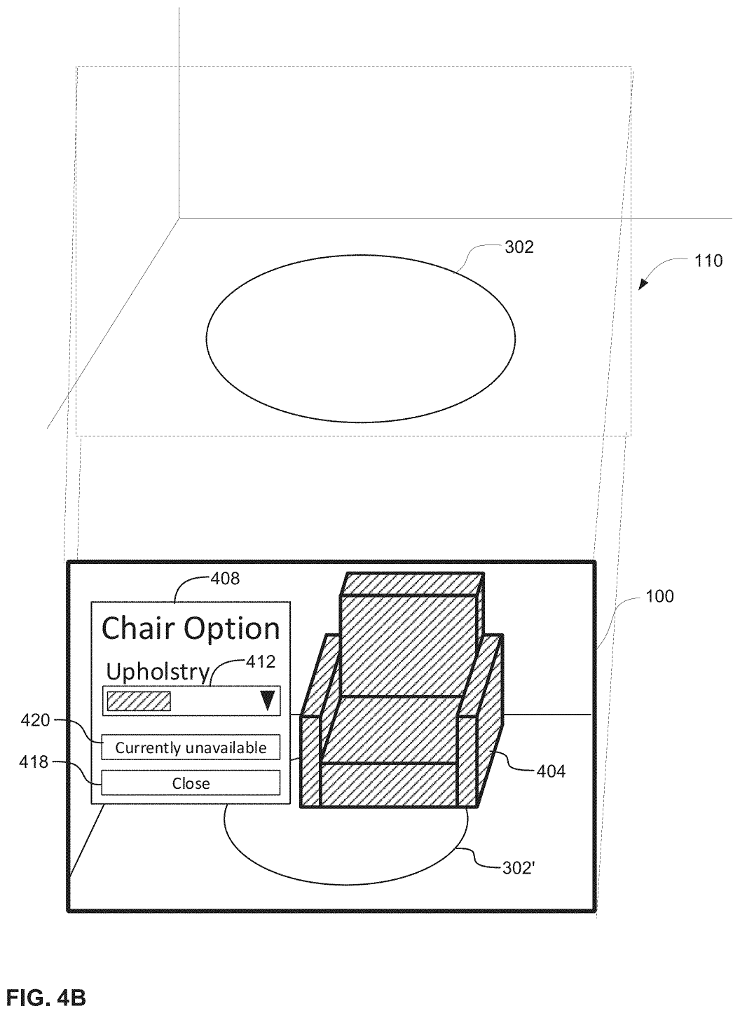

FIGS. 4A-4B illustrate exemplary ways in which electronic device 100 presents an option associated with a virtual object according to some embodiments. As shown in FIG. 4A, in some embodiments, electronic device 100 can present a representation of physical environment 110, including a XR representation 302′ of a rug 302 in the physical environment 110 and a virtual chair 404. In some embodiments, virtual chair 404 can correspond to a physical chair that is available for purchase through a retailer and/or manufacturer.

In some embodiments, the electronic device 100 presents the virtual chair 404 based on a file having the same or a similar format as file 700 described below with reference to FIG. 7. In some embodiments, the file defining virtual sofa 304 illustrated in FIGS. 3A-3D and the file defining virtual chair 404 can have the same file format. The file defining virtual chair 404 can be provided by a source of the virtual chair 404. In some embodiments, the source is a second electronic device (e.g., a server) associated with a retailer and/or manufacturer of the physical chair that corresponds to virtual chair 404. The file corresponding to virtual chair 404 can include the configuration of one or more characteristics with which the virtual chair 404 is presently displayed and an indication of the source of the virtual chair 404. For example, the one or more characteristics can include options available to a customer looking to purchase the physical chair corresponding to virtual chair 404, such as upholstery style, foot style, and size. Other characteristics are possible. In some embodiments, the virtual chair 404 is displayed in a XR environment that is not uniquely associated with the source of the virtual chair 404. For example, rather than displaying virtual chair 404 in a XR environment associated with an online store of the source of virtual chair 404, the virtual chair 404 can be displayed in a XR environment in which virtual objects from a plurality of sources can be displayed. In some embodiments, the other virtual objects in the XR environment can be other virtual objects corresponding to physical objects available for purchase, one or more items of content, one or more application windows, or other virtual content accessible to the electronic device 100.

In FIG. 4A, the virtual chair 404 is concurrently displayed with a menu 408 including an upholstery menu 412, an option 416 to purchase the physical chair corresponding to virtual chair 404, and an option 418 to close the menu 408, for example. In some embodiments, the virtual chair 404 is displayed with an upholstery option selected in menu 412 and the pricing information included in option 416 can be pricing information associated with a physical chair having the upholstery option selected in menu 412. In some embodiments, in response to a sequence of one or more inputs including selection of a different upholstery option, the electronic device 100 transmits a request to the source of virtual chair 404 for an indication of the availability of a physical chair with the user-selected option. In response, the electronic device 100 receives an indication of the availability of the virtual chair 404 with the user-selected configuration.

For example, in FIG. 4B, the electronic device 100 presents the virtual chair 404 with a different upholstery option than the upholstery option selected in FIG. 4A. In some embodiments, the selected upholstery option is not currently available for purchase, and the electronic device 100 updates menu 408 to include an indication 420 that the selected configuration of the virtual chair 404 is unavailable. As shown in FIG. 4B, the electronic device 100 displays the virtual chair 404 with the updated upholstery configuration even though the configuration is not available for purchase. In some embodiments, in accordance with a determination that the selected configuration is not available, the electronic device 100 forgoes updating the virtual chair 404.

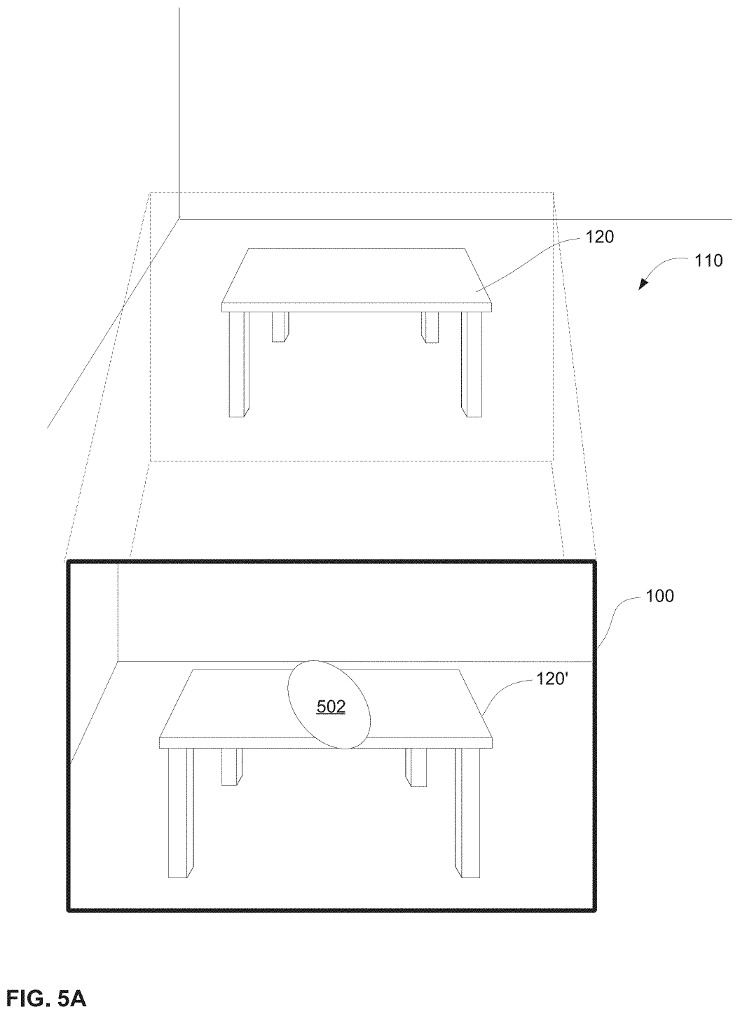

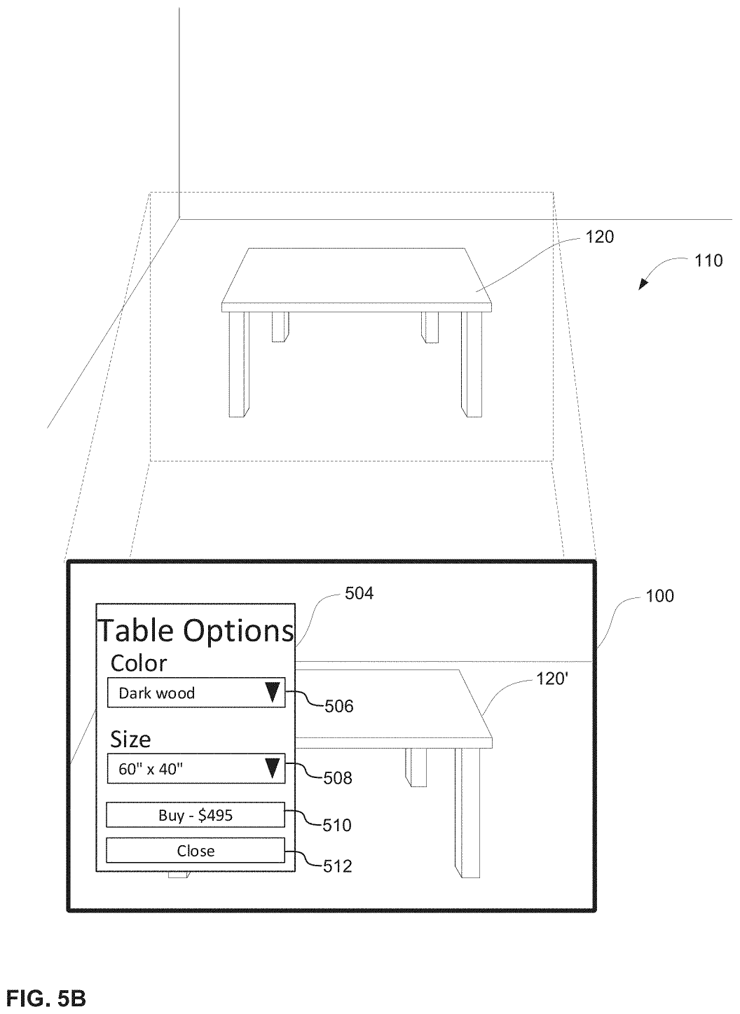

In some embodiments, in addition to presenting virtual objects corresponding to real objects available for purchase, electronic device 100 is able to identify a real object and present purchasing information, including available options and pricing associated with the real object. FIGS. 5A-5B illustrate exemplary ways in which an electronic device 100 presents configuration information associated with a real object in the physical environment of the electronic device 100 in accordance with some embodiments.

In FIG. 5A, the electronic device 100 presents a XR environment including a representation 120′ of a real table 120 present in the physical environment of the electronic device. In some embodiments, the real table 120 is associated with a catalog of products available for purchase. As shown in FIG. 5A, electronic device 100 can detect selection of the representation 120′ of real table 120. For example, the user can select the representation 120′ by touching the representation 120′ on a touch screen of electronic device 100. In some embodiments, other inputs and input devices are possible.

In some embodiments, in response to the user input illustrated in FIG. 5A, the electronic device 100 presents a menu 504 including options associated with real table 120. For example, the menu 504 can include menus 506 and 508 indicating the configuration of real table 120, an option 510 to purchase another table with the same configuration as real table 120, an option 512 to cease display of menu 504. In some embodiments, the menu 504 is presented based on a file associated with the table 120 that has the same format as the files defining virtual sofa 304 and virtual chair 404. In some embodiments, one or more of these files has a similar format or the same format as the file described below with reference to FIG. 7.

In some embodiments, the user is able to select different values for characteristics of a real table using menus 506 and 508. For example, if the user wishes to purchase a real table that has a different color than real table 120, the user can select a different color from menu 506. In some embodiments, if the user wishes to purchase a real table that has a different size than real table 120, the user can select a different size from menu 508. In some embodiments, in response to detecting the user change one or more of the characteristics in menu 504, the electronic device 100 can update the pricing information included in the option 510 to purchase the table (e.g., after receiving the pricing information from the source of the table). In some embodiments, the electronic device 100 can display a representation of a virtual table with the user-selected configuration in response to detecting the user change one or more characteristics of the table in menus 506 and 508. In some embodiments, the electronic device 100 displays the virtual table in place of displaying the representation 120′ of the real table 120. In some embodiments, the electronic device 100 displays the virtual table adjacent to the representation 120′ of real table 120.

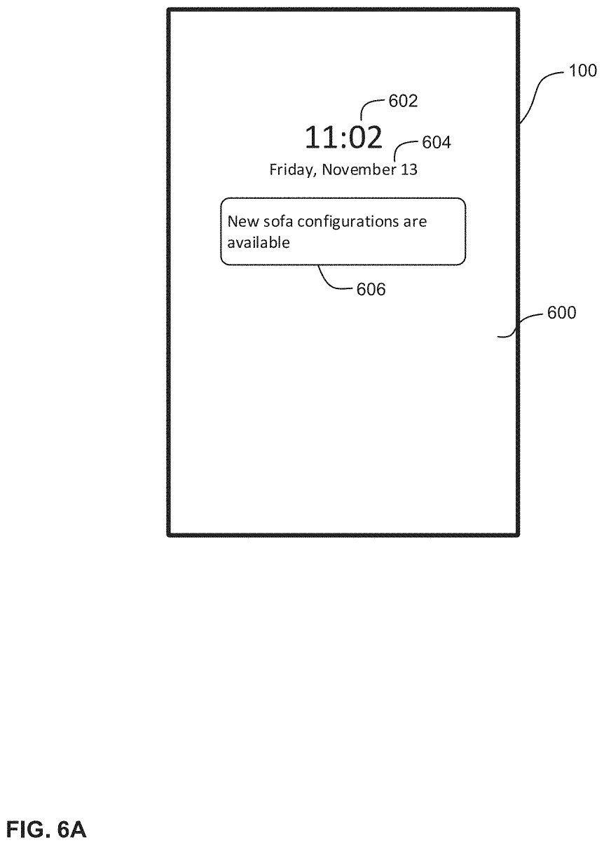

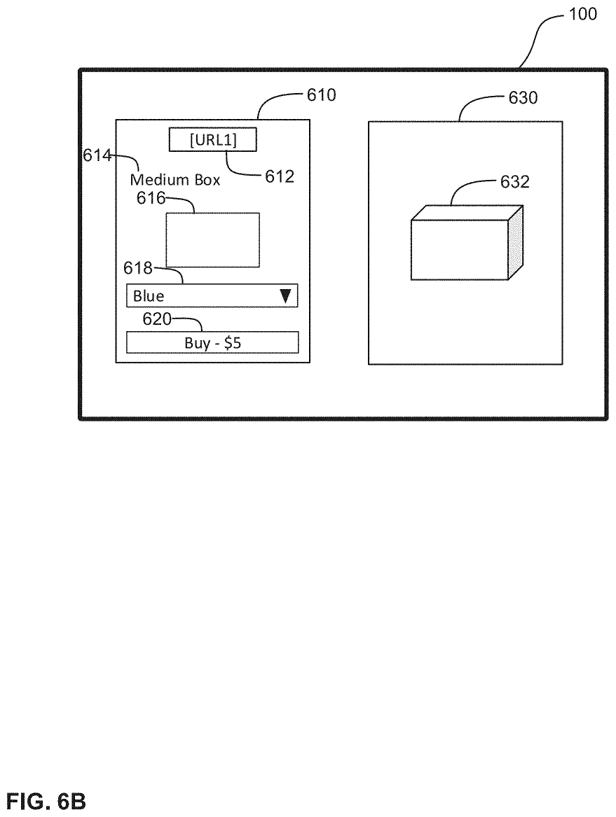

FIG. 6A illustrates an exemplary notification 606 related to a virtual object in accordance with some embodiments. The notification 606 can indicate a change to metadata associated with a virtual object, such as a change in the configurations that are available, a change in the price, availability of a special offer related to the real object associated with the virtual object, and the like.

In some embodiments, the user can request notifications associated with particular objects and/or particular events related to the objects. In some embodiments, the electronic device 100 can present notifications similar to notification 606 that are associated with virtual objects saved by the user, for example, in an object management system or application. The user can set and modify settings indicating which types of notifications should be received for each object, or for all objects. For example, the user may wish to receive a notification when a particular color of a sofa is available for purchase, when an item of clothing goes on sale, or when the price changes for any of the objects saved by the user. In some embodiments, the user can disable notifications related to virtual objects one object at a time or once for all virtual objects for which the user has subscribed to notifications.

In some embodiments, a source of a virtual object can transmit an indication of the notification 606 to the electronic device 100. For example, in response to detecting an update to the metadata of a virtual object, the source of that virtual object can transmit an indication of the change of the metadata to the electronic device 100. In some embodiments, in response to receiving the indication of the change of the metadata from the source of the object, the electronic device 100 presents the notification 606.

In FIG. 6A, the electronic device 100 displays the notification 606 in a home screen user interface 600 as an example. The home screen user interface 600 can be a system user interface of the electronic device 100 (e.g., a user interface associated with the operating system of the electronic device 100, rather than with a particular application accessible to the electronic device 100). In some embodiments, the electronic device 100 can display notification 606 while displaying other user interfaces, such as other system user interfaces (e.g., a home screen user interface, a settings user interface, a notification user interface) or while displaying the user interface(s) of one or more applications, including applications associated with the notification 606 and applications not associated with the notification 606. For example, the electronic device 100 can display the notification 606 in a system user interface object overlaid on one or more other user interfaces.

In FIG. 6B, the electronic device 100 presents a web browsing user interface 610 and a virtual collection user interface 630 as examples. For example, the web browsing user interface 610 displays an online store selling a respective real object (e.g., a box). In some embodiments, the web browsing user interface 610 includes an indication 612 of the URL of the website currently being displayed, text 614 indicating the name of the real object, a virtual object 616 corresponding to the real object, a menu 618 for changing a characteristic (e.g., the color) of the real object, and a selectable option that, when selected, causes the electronic device 100 to initiate a process to purchase the real object. In some embodiments, the virtual object 616 is generated based on a file similar to the file 700 described below with reference to FIG. 7. In some embodiments, the virtual collection user interface 630 includes a virtual object 632 that is based on the same file as the virtual object 616 included in the web browsing user interface 610.

Although virtual object 616 and virtual object 632 correspond to the same file and the same real object, in some embodiments, as shown in FIG. 6B, the virtual objects 616 and 632 have different appearances from each other because they are displayed in user interfaces for different applications. For example, the virtual object 616 is displayed in the web browsing user interface 610 with a two-dimensional image and metadata related to the object, such as the name 614 of the object, and the menu 618 for a characteristic of the object embedded in the web page presented by the web browsing user interface 610, while the virtual object 632 is displayed as a three-dimensional image in the virtual collection user interface 630. In some embodiments, in response to detecting selection of the virtual object 632 in the virtual collection user interface 630, the electronic device 100 presents the object metadata in a menu similar to menu 504 illustrated in FIG. 5B.

In some embodiments, the virtual object file is portable and retains changes made by the user or the source of the object to the metadata associated with the file. Thus, if the user were to change the color of the object in the web browsing user interface 610, save the object file, then open the object file in the virtual collection user interface 630, the electronic device 100 would display the virtual object 632 in the color selected by the user in the web browsing user interface 610, for example. As another example, if the price of the object changes, the web browsing user interface 610 and the virtual collection user interface 630 would update display of the metadata associated with the virtual object to reflect the price change.

In some embodiments, the electronic device 100 can facilitate display of the virtual object in multiple user interfaces. For example, the electronic device 100 can detect the file associated with the virtual object 616 while displaying the web browsing user interface 610 and display the virtual object 632 in the virtual collection user interface 630. In some embodiments, the virtual object 616 is based on a file having the format of file 700 in FIG. 7. In some embodiments, the representation of the virtual object 616 displayed in the web browsing user interface 610 is stored in an image file different from but included in or associated with the virtual object file with the format of file 700. By identifying virtual objects in a plurality of applications, in some embodiments, the user can save a plurality of virtual objects with customized characteristics from a plurality of sources, applications, and the like in an application chosen by the user, such as the virtual collection application 630. In some embodiments, if an update is made to the metadata any of the saved objects by the source(s) of the saved objects, the electronic device 100 can display the updated virtual objects in the virtual collection application 630.

FIG. 7 illustrates an exemplary file 700 defining a virtual object corresponding to a real object in accordance with some embodiments. In some embodiments, the electronic device 100 can display one or more virtual objects (e.g., virtual sofa 304, virtual chair 404) and/or display options related to one or more real objects (e.g., real table 120) based on exemplary file 700.

In some embodiments, file 700 can be provided by a source of the object that corresponds to the file 700. The file 700 can include indications 702a-702c of one or more attributes of the object, an indication 706 of the source of the object, an indication 708 of authentication information (e.g., digital rights management) of the object, pricing information 710 associated with the object, and an indication 712 of one or more retailers of the object.

In some embodiments, the indication 706 of the source of the object can include information for contacting the source of the object to obtain updated information about the object, such as the availability of various configurations of the object and/or pricing information. In some embodiments, the indication 708 of authentication information can include a private signature that can be verified by a third-party server (e.g., an electronic device other than the electronic device that presents the virtual object or the source of the virtual object). In some embodiments, the third-party server can verify the signature if the signature includes information corresponding to authentication by the manufacturer of the physical object corresponding to the virtual object that grants the source of the object (e.g., a retailer of the object) permission to market and sell the physical object corresponding to the virtual object. It should be understood that, in some embodiments, a respective physical object can be sold by multiple manufacturer-authorized retailers and in these situations, two virtual objects can correspond to the same product, but be associated with different sources and, therefore, have different configurations (e.g., attributes 702a-c and options 704a-i) available. In some embodiments, the indications 702a-c of each respective attribute of the object can include a plurality of options 704a-i associated with the respective attribute. For example, the file associated with virtual sofa 304 can include indications for the upholstery and the feet of the sofa, and these indications can include indications of the available options for each attribute. It should be appreciated that the number of attributes for a respective object, and the number of options for each attribute, can vary widely among objects and attributes. In some embodiments, the indication 704a-i of each option of each attribute can include information about the availability of the respective option.

In some embodiments, file 700 can be stored on the electronic device 100 and updated by the source of the object (e.g., in response to a request from the electronic device 100, automatically at predetermined time intervals, automatically whenever availability for one or more attributes changes). For example, updates to the file 700 can include adding or removing one or more attributes 702a-c, adding or removing one or more options 704a-i available for one or more attributes, updates to the pricing 710 of the object, updates to the retailers 712, and/or updates to the authentication data 708 (e.g., expiration and/or renewal of digital rights management for the object). In some embodiments, file 700 can be stored by the source of the object and the electronic device 100 can request information from file 700 in response to user requests to view and/or update the virtual object defined by file 700.

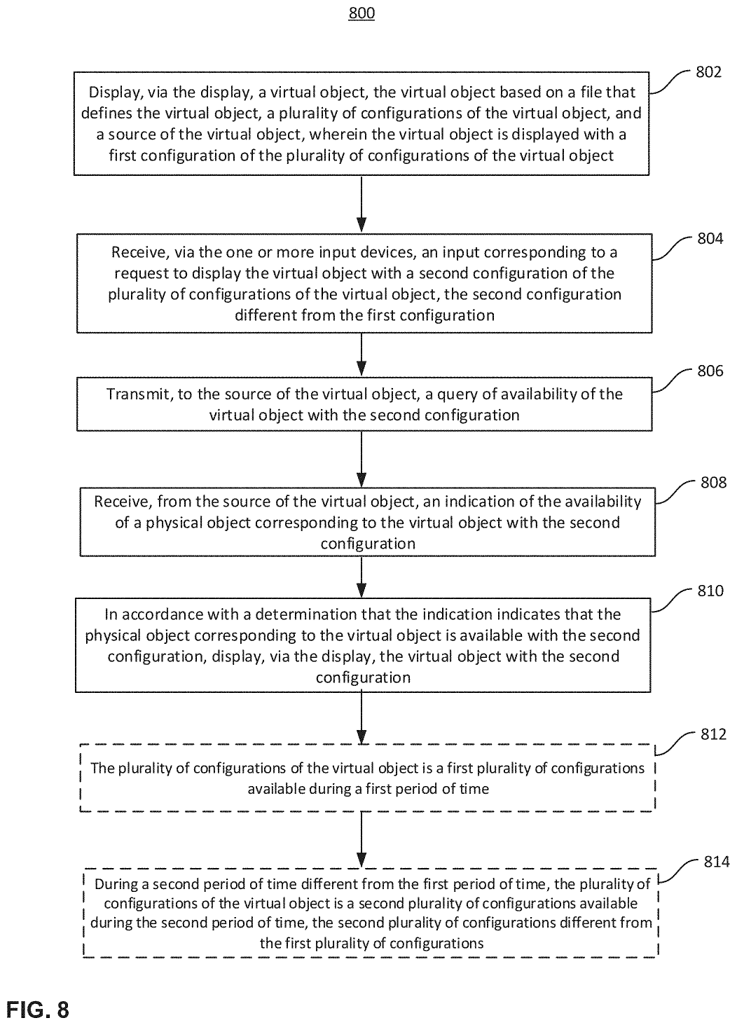

FIG. 8 illustrates an example process 800 for presenting virtual objects according to some embodiments. Process 800 is optionally performed at an electronic device such as device 100 or device 200. Some operations in process 800 are optionally combined and/or optionally omitted. The order of some operations in process 800 is optionally changed, in some embodiments.

In some embodiments, operations of process 800 are performed at an electronic device in communication with a display generation component and one or more input devices. A computer-generated environment is optionally displayed/presented via the display generation component (e.g., using display generation component(s) 214). The computer-generated environment includes, in some embodiments, a representation of the real-world environment (or at least a representation of one or more portions of a real-world environment) and, optionally, one or more virtual objects. In some embodiments, the representation of the real-world environment, or at least one or more portions of a real-world environment, is captured using one or more input devices, such as image sensor(s) 210.

In some embodiments, the electronic device displays (802), via the display, a virtual object, the virtual object based on a file that defines the virtual object, a plurality of configurations of the virtual object, and a source of the virtual object, wherein the virtual object is displayed with a first configuration of the plurality of configurations of the virtual object. In some embodiments, the electronic device receives (804), via the one or more input devices, an input corresponding to a request to display the virtual object with a second configuration of the plurality of configurations of the virtual object, the second configuration different from the first configuration. In some embodiments, the electronic device transmits (806), to the source of the virtual object, a query of availability of the virtual object with the second configuration. In some embodiments, the electronic device receives (808), from the source of the virtual object, an indication of the availability of a physical object corresponding to the virtual object with the second configuration. In some embodiments, in accordance with a determination that the indication indicates that the physical object corresponding to the virtual object is available with the second configuration, the electronic device displays (810), via the display generation component, the virtual object with the second configuration.

In some embodiments, in accordance with a determination that the indication indicates that the virtual object is not available with the second configuration, the electronic device displays, via the display, an indication that the virtual object is not available with the second configuration. In some embodiments, the indication of availability is an indication of availability for purchase of the physical object corresponding to the virtual object. In some embodiments, the indication of availability is an availability of the virtual object for display by the electronic device. In some embodiments, the electronic device transmits the query of availability of the virtual object with the second configuration to the source of the virtual object in accordance with a determination that the file that defines the virtual object satisfies one or more criteria. In some embodiments, in accordance with a determination that the file that defines the virtual object does not satisfy the one or more criteria, the electronic device forgoes transmitting the query of availability of the virtual object with the second configuration. In some embodiments, the one or more criteria require that the file that defines the virtual object includes valid digital rights management information. In some embodiments, the indication indicates whether a plurality of characteristics of the second configuration are each available. In some embodiments, the indication indicates whether a plurality of characteristics of the second configuration are available in combination. In some embodiments, the virtual object is initially accessed via an environment associated with the source of the object and later accessed via an environment that is independent from the source of the virtual object. In some embodiments, the electronic device displays, via the display, a plurality of configurations of a second virtual object, and a source of the second virtual object. In some embodiments, the second virtual object is defined by a second file, and the second file and the file that defines the virtual object have a common file format. In some embodiments, the electronic device determines whether the file that defines the object includes a valid security credential. In some embodiments, displaying the virtual object comprises displaying the virtual object in response to a determination that the file includes a valid security credential. In some embodiments, the electronic device identifies, based on an image of a respective real object, a respective virtual object corresponding to the respective real object. In some embodiments, the electronic device requests, from a catalog, availability of the respective virtual object. In some embodiments, the electronic device receives, from the catalog, a first indication of the availability of the respective virtual object. In some embodiments, the electronic device presents a user interface element indicating the availability of the respective virtual object. In some embodiments, the plurality of configurations of the virtual object is a first plurality of configurations available during a first period of time (812). In some embodiments, during a second period of time different from the first period of time, the plurality of configurations of the virtual object is a second plurality of configurations available during the second period of time, the second plurality of configurations different from the first plurality of configurations (814).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display and one or more input devices:
displaying, via the display, a virtual object, the virtual object based on a file that defines the virtual object, a plurality of configurations of the virtual object, and a source of the virtual object, wherein the virtual object is displayed with a first configuration of the plurality of configurations of the virtual object;
receiving, via the one or more input devices, an input corresponding to a request to display the virtual object with a second configuration of the plurality of configurations of the virtual object, the second configuration different from the first configuration;
transmitting, to the source of the virtual object, a query of availability of the virtual object with the second configuration;
receiving, from the source of the virtual object, an indication of the availability of a physical object corresponding to the virtual object with the second configuration; and
in accordance with a determination that the indication indicates that the physical object corresponding to the virtual object is available with the second configuration, displaying, via the display, the virtual object with the second configuration.

2. The method of claim 1, further comprising:
in accordance with a determination that the indication indicates that the virtual object is not available with the second configuration, displaying, via the display, an indication that the virtual object is not available with the second configuration.

3. The method of claim 1, wherein the indication of availability is an indication of availability for purchase of the physical object corresponding to the virtual object.

4. The method of claim 1, wherein the indication of availability is an availability of the virtual object for display by the electronic device.

5. The method of claim 1, wherein the electronic device transmits the query of availability of the virtual object with the second configuration to the source of the virtual object in accordance with a determination that the file that defines the virtual object satisfies one or more criteria, and the method further comprises:
in accordance with a determination that the file that defines the virtual object does not satisfy the one or more criteria, forgoing transmitting the query of availability of the virtual object with the second configuration.

6. The method of claim 5, wherein the one or more criteria require that the file that defines the virtual object includes valid digital rights management information.

7. The method of claim 1, wherein the indication indicates whether a plurality of characteristics of the second configuration are each available.

8. The method of claim 1, wherein the indication indicates whether a plurality of characteristics of the second configuration are available in combination.

9. The method of claim 1, wherein the virtual object is initially accessed via an environment associated with the source of the object and later accessed via an environment that is independent from the source of the virtual object.

10. The method of claim 1, further comprising:
displaying, via the display, a plurality of configurations of a second virtual object, and a source of the second virtual object,
wherein the second virtual object is defined by a second file, and the second file and the file that defines the virtual object have a common file format.

11. The method of claim 1, further comprising:
determining whether the file that defines the object includes a valid security credential, wherein displaying the virtual object comprises displaying the virtual object in response to a determination that the file includes a valid security credential.

12. The method of claim 1, further comprising:
identifying, based on an image of a respective real object, a respective virtual object corresponding to the respective real object;
requesting, from a catalog, availability of the respective virtual object;
receiving, from the catalog, a first indication of the availability of the respective virtual object; and
presenting a user interface element indicating the availability of the respective virtual object.

13. The method of claim 1, wherein:
the plurality of configurations of the virtual object is a first plurality of configurations available during a first period of time, and
during a second period of time different from the first period of time, the plurality of configurations of the virtual object is a second plurality of configurations available during the second period of time, the second plurality of configurations different from the first plurality of configurations.

14. The method of claim 1, further comprising:
opening the file that defines the virtual object using a respective application accessible to the electronic device; and
displaying, via the display, a representation of the virtual object with the respective application, wherein displaying the representation of the virtual object with the respective application includes:
in accordance with a determination that the respective application is a first application, displaying, via the display, a first representation of the virtual object with a first appearance, and
in accordance with a determination that the respective application is a second application different from the first application, displaying, via the display, a second representation of the virtual object different from the first representation, the second representation having a second appearance different from the first appearance.

15. The method of claim 1, further comprising:
while the file that defines the virtual object is not open via the electronic device, receiving, via the one or more input devices, an input corresponding to a request to display the virtual object; and
in response to the input corresponding to the request to display the virtual object:
displaying, via the display, the virtual object, wherein:
in accordance with a determination that the file that defines the virtual object was saved with a third configuration, displaying the virtual object includes displaying the virtual object with the third configuration, and
in accordance with a determination that the file that defines the virtual object was saved with a fourth configuration different from the third configuration, displaying the virtual object includes displaying the virtual object with the fourth configuration.

16. The method of claim 1, further comprising:
receiving, from the source of the virtual object, an indication of a change of a characteristic of the virtual object;
in response to receiving the indication of the change of the characteristic of the virtual object:
presenting an indication of the change of the characteristic of the virtual object, wherein the indication of the change of the characteristic of the virtual object is presented by the electronic device irrespective of whether the electronic device has access to an application provided by the source of the virtual object.

17. The method of claim 1, further comprising:
displaying, via the display, a representation of the physical object corresponding to the virtual object, wherein the representation of the physical object is based on a second file different from the file that defines the virtual object; and
in accordance with displaying the representation of the physical object based on the second file, identifying the file that defines the virtual object.

18. The method of claim 16, further comprising:
in accordance with identifying the file that defines the virtual object, displaying, via the display, the virtual object.

19. An electronic device, comprising:
one or more processors;
memory; and
one or more programs, wherein the one or more programs are stored in the memory and configured to be executed by the one or more processors, the one or more programs including instructions for:
displaying, via a display, a virtual object, the virtual object based on a file that defines the virtual object, a plurality of configurations of the virtual object, and a source of the virtual object, wherein the virtual object is displayed with a first configuration of the plurality of configurations of the virtual object;
receiving, via one or more input devices, an input corresponding to a request to display the virtual object with a second configuration of the plurality of configurations of the virtual object, the second configuration different from the first configuration;
transmitting, to the source of the virtual object, a query of availability of the virtual object with the second configuration;
receiving, from the source of the virtual object, an indication of the availability of a physical object corresponding to the virtual object with the second configuration; and
in accordance with a determination that the indication indicates that the physical object corresponding to the virtual object is available with the second configuration, displaying, via the display, the virtual object with the second configuration.

20. A non-transitory computer readable storage medium storing one or more programs, the one or more programs comprising instructions, which when executed by one or more processors of an electronic device, cause the electronic device to perform a method comprising:
displaying, via a display, a virtual object, the virtual object based on a file that defines the virtual object, a plurality of configurations of the virtual object, and a source of the virtual object, wherein the virtual object is displayed with a first configuration of the plurality of configurations of the virtual object;
receiving, via one or more input devices, an input corresponding to a request to display the virtual object with a second configuration of the plurality of configurations of the virtual object, the second configuration different from the first configuration;
transmitting, to the source of the virtual object, a query of availability of the virtual object with the second configuration;
receiving, from the source of the virtual object, an indication of the availability of a physical object corresponding to the virtual object with the second configuration; and
in accordance with a determination that the indication indicates that the physical object corresponding to the virtual object is available with the second configuration, displaying, via the display, the virtual object with the second configuration.
